(19) United States
(12) Patent Application Publication
(10) Pub. No.: US 2012/0284086 A1
(43) Pub. Date: Nov. 8, 2012

(54) FUEL STORE PROFIT OPTIMIZATION

(75) Inventor: David McCaffrey, Manchester (GB)

(73) Assignee: KNOWLEDGE SUPPORT SYSTEMS LTD., Manchester (GB)

(21) Appl. No.: 13/100,566

(22) Filed: May 4, 2011

(51) Int. Cl. G06Q 10/00

(52) U.S. Cl. 705/7.35; 705/7.11

(57) ABSTRACT

A computer-implemented method of generating fuel price data for a retail fuel site, the method being implemented in a computer comprising a memory in communication with a processor. The method comprises receiving, as input to the processor, data indicating a relationship between fuel sales and store sales at said retail fuel site and receiving, as input to the processor, data indicating a relationship between fuel price and fuel sales at said retail fuel site. The data indicating a relationship between fuel sales and store sales at said retail fuel site and said data indicating a relationship between fuel price and fuel sales at said retail fuel site are processed by the processor to generate said fuel price data.

### TECHNICAL FIELD

The present invention relates to generation of fuel price data.

### BACKGROUND OF THE INVENTION

In many industries, commercial organisations have to determine prices at which their products are to be sold. Determination of such prices will need to take into account various factors. For example, a particular commercial organisation may wish to ensure that its prices are within a predetermined limit of a particular competitor's prices. Similarly, a commercial organisation may wish to ensure that a particular constraint is applied such that prices of different products sold by that organisation have a predetermined relationship with one another.

A particular industry in which prices need to be determined is the fuel industry. In particular, it is necessary to determine prices at which fuel is to be sold at retail fuel sites. The price charged by a particular retail fuel site will be determined by a number of different parameters. For example, prices charged by the retail fuel site's competitors are likely to need to be taken into account, as are prices of various other products sold by the retail fuel site. Typically, a plurality of retail fuel sites operate in a particular region, and prices charged by different retail fuel sites in a particular region will routinely need to be taken into account. Additionally, prices charged in different regions in associated retail fuel sites may also need to be taken into account.

Traditionally, prices at which retail fuel sites sell fuel have been determined by skilled analysts who have mentally collated and processed data representing various parameters which need to be taken into account. Having carried out this processing, analysts can typically determine pricing, often convening at a meeting at which a plurality of pricing analysts make various strategy decisions.

More recently, automated systems for determining retail fuel prices have been used. In these automated systems data required for determining pricing is collected and provided to a pricing system which is often located remotely from the retail site. The pricing system uses the provided data together with other information to determine information useful for optimising fuel prices at the retail site. The other information may include a desired pricing strategy such as pricing that optimises sales volumes or that optimises retail site profit. The information generated by the pricing system generally takes the form of recommended pricing for fuels that satisfies the desired pricing strategy, but may also include other useful information such as reports and predictions of competitor prices.

There remains a need for improvements in pricing systems and methods.

### SUMMARY

It is an object of the invention to provide improvements in systems and methods for generating retail fuel site price data.

According to a first aspect of the invention there is provided a computer-implemented method of generating fuel price data for a retail fuel site, the method being implemented in a computer comprising a memory in communication with a processor. The method comprises receiving, as input to the processor, data indicating a relationship between fuel sales and store sales at said retail fuel site and receiving, as input to the processor, data indicating a relationship between fuel price and fuel sales at said retail fuel site. The data indicating a relationship between fuel sales and store sales at said retail fuel site and the data indicating a relationship between fuel price and fuel sales at said retail fuel site is processed to generate said fuel price data.

In this way, fuel price data is generated taking into account fuel sales but additionally taking into account store sales, corresponding to sales at the site which are not fuel sales. For example, the fuel price data may be prices for each of a plurality of fuel types sold at the retail fuel site. At some stores it may be advantageous to reduce the prices for some or all fuel types in order to increase the number of customers at the store, and thereby increase store profit, as the decrease in profit from fuel may be more than compensated for by the increase in store profit. By generating fuel price data indicating a relationship between fuel sales and store sales at said retail fuel site and the data indicating a relationship between fuel price and fuel sales at said retail fuel site it is possible to determine if such a fuel price reduction results in a net increase in profit at the retail fuel site.

Said processing may comprise generating a volume fuel sales target for said retail fuel site based upon said data indicating a relationship between fuel sales and store sales at said retail fuel site and said data indicating a relationship between fuel price and fuel sales at said retail fuel site, and generating said fuel price data based upon said generated volume fuel sales target.

In general terms, it is desirable to optimise profit across a network of associated retail fuel sites, for example retail fuel sites that are owned by a single entity. By generating a volume sales target for retail fuel sites based upon a relationship between fuel sales and store sales at said retail fuel site and the data indicating a relationship between fuel price and fuel sales at said retail fuel site, it is possible to effectively reassign fuel sales volume to sites at which store profit is relatively high from sites at which store profit is relatively low such that total fuel sales volume is maintained and profit across the network is increased.

Generating a volume fuel sales target for said retail fuel site may comprise receiving, as input to the processor, data indicating a relationship between fuel sales and store sales at a plurality of associated retail fuel sites, said plurality of associated retail fuel sites including said retail fuel site, receiving, as input to the processor, data indicating a relationship between fuel price and fuel sales at said plurality of associated retail fuel sites and receiving, as input to the processor, a total volume fuel sales target for said plurality of associated retail fuel sites. The total volume fuel sales target for said plurality of associated retail fuel sites together with said data indicating a relationship between fuel sales and store sales at said plurality of associated retail fuel sites and said data indicating a relationship between fuel price and fuel sales at said plurality of associated retail fuel sites may be processed to generate said volume fuel sales target for said retail fuel site.

Processing said total volume fuel sales target for said plurality of associated retail fuel sites together with said data indicating a relationship between fuel sales and store sales at said retail fuel site and said plurality of associated retail fuel sites and said data indicating a relationship between fuel price and fuel sales at said retail fuel site and said plurality of associated retail fuel sites to generate said volume fuel sales target for said retail fuel site may comprise generating, by the processor, a price for said retail fuel site based upon said total volume sales target and processing said generated price for said retail fuel site to generate said volume fuel sales target for said associated retail fuel site.

Generating a price for said retail fuel site based upon said total volume fuel sales target may comprise performing an optimisation operation, said optimisation operation having said total volume fuel sales target as a constraint.

The optimisation operation may be further based upon average fuel price data from each of said plurality of associated retail fuel sites and average fuel price data from each of a plurality of competitor retail fuel sites.

The optimisation operation may be further based upon relationships between said plurality of associated retail fuel sites and said plurality of competitor retail fuel sites.

The relationships between each of said plurality of associated retail fuel sites and said plurality of competitor retail fuel sites may be determined based upon a relationship between the data indicating a relationship between fuel sales and store sales at the associated retail fuel site and the data indicating a relationship between fuel price and fuel sales at the retail fuel site.

The optimisation operation may determine fuel price data which provides an optimal profit at said retail fuel site.

The optimal profit at said retail fuel site may be based upon profit associated with fuel sales at said retail fuel site and profit associated with store sales at said retail fuel site.

The fuel price data may be generated based upon a volume fuel sales target for said retail fuel site.

In this way, fuel prices may be set such that total profit at a particular site is optimised whilst taking into account site store sale profit as described above.

Processing said volume fuel sales target to generate said fuel price data may comprise performing an optimisation operation, said optimisation operation having said volume fuel sales target as a constraint.

The optimisation operation may be further based upon relationships between said retail fuel site and a plurality of competitor retail fuel sites.

The optimisation operation may determine fuel price data which provides an optimal profit at said retail fuel site.

The optimal profit at said retail fuel site may be based upon profit associated with fuel sales at said retail fuel site and profit associated with store sales at said retail fuel site.

According to a second aspect of the invention there is provided a computer-implemented method of generating price data for a retail fuel site, the method being implemented in a computer comprising a memory in communication with a processor. The method comprises receiving, as input to the processor, a model having a plurality of parameters, the model being based upon a relationship between fuel sales and store sales at the retail fuel site and being arranged to generate a profit based upon values of said plurality of parameters. First values for said parameters are received as input to the processor and the model and the first values are processed to generate a first profit value. Second values for said parameters are received as input to the processor and the model and the second values are processed to generate a second profit value and the price data for said retail fuel site is determined based upon said first and second profit values.

In this way different possible scenarios at a retail fuel site can be modelled to determine whether changes at the retail fuel site may be beneficial, for example by increasing profit and/or increasing fuel sales volume.

The first values for said parameters may be based upon current values for said parameters and said second values for said parameters may be based upon values other than current values for said parameters.

The profits generated by said model may be based upon profit from fuel sales and profit from store sales.

The model may model relationships between said retail fuel site and a plurality of competitor retail fuel sites.

The parameters may include a relationship between fuel sales and store sales, a fuel sale margin, a store sale margin and a relationship between fuel price and fuel sales.

Price data may be generated for a plurality of associated retail fuel sites and said price data may be determined for said retail fuel site based upon said first and second profit values for each of said plurality of associated retail fuel sites.

The plurality of associated retail fuel sites may each have a predetermined relationship between an associated relationship between fuel sales and store sales and an associated relationship between fuel price and fuel sales.

It will be appreciated that the first and second aspects of the invention can be combined.

Aspects of the invention can be implemented in any convenient form. For example computer programs may be provided to carry out the methods described herein. Such computer programs may be carried on appropriate computer readable media which term includes appropriate non-transient tangible storage devices (e.g. discs). Aspects of the invention can also be implemented by way of appropriately programmed computers and other apparatus.

### BRIEF DESCRIPTION OF THE DRAWINGS

Embodiments of the invention will now be described, by way of example, with reference to the accompanying drawings, in which:

FIG. 1 is a schematic illustration of part of a network of associated retail fuel sites in communication with a pricing system;

FIG. 2 is a schematic illustration of the pricing system of FIG. 1;

FIG. 2A is a schematic functional block diagram of part of the pricing system of FIG. 1;

FIG. 3 is a schematic illustration showing a computer associated with the pricing system of FIG. 2 in further detail;

FIG. 4 is a screen shot of a graphical user interface suitable for providing data to the data engine of FIG. 2;

FIG. 5 is a screenshot of a pricing page for displaying information to a user;

FIG. 6 is a screenshot showing data that may be displayed as part of a pricing page such as the pricing page of FIG. 5;

FIG. 7 shows part of the screenshot of FIG. 5 in more detail;

FIG. 8 is an entity diagram of a database suitable for storing and managing data to be displayed as part of the pricing page of FIG. 5;

FIG. 9 is a schematic functional block diagram of a pricing system for generating prices that are optimal across a network;

FIG. 10 is a flowchart showing processing to generate an optimised site level volume constraint for use in a pricing system intended to generate prices that are optimal across a network;

FIG. 11 is a flowchart showing processing to determine fuel sale volume targets;

FIGS. 12A and 12B illustrate categorisation of retail fuel sites into a plurality of categories;

FIG. 13 is a flowchart showing processing to model a retail fuel site scenario;

FIG. 14 is a user interface suitable for receiving input data associated with a retail fuel site scenario;

FIG. 15 shows output data generated from modelling a retail fuel site scenario;

FIG. 16 is a user interface suitable for modelling input data associated with a retail fuel site scenario; and

FIGS. 16A to 16H are each a graph showing output data resulting from modelling input data received by the user interface of FIG. 16.

### DETAILED DESCRIPTION

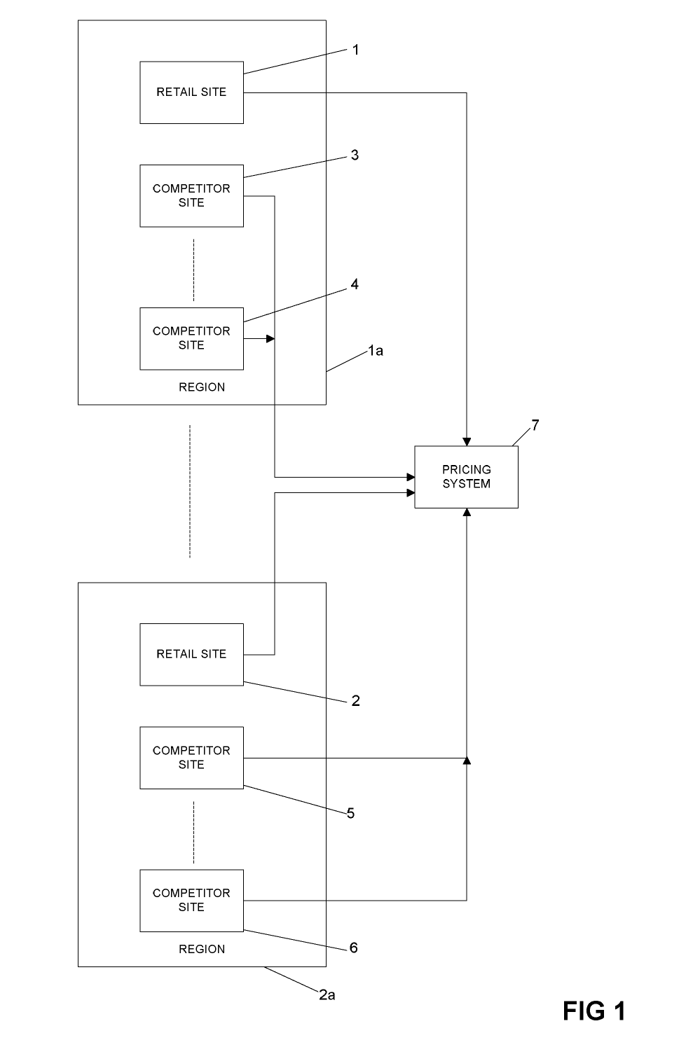

Referring first to FIG. 1 part of a network of associated retail fuel sites, 1, 2 is illustrated. Each of the associated retail fuel sites may be, for example, owned or operated by a single commercial entity, or may be supplied by a particular fuel supplier. Each of the associated retail fuel sites 1, 2 has an associated region 1a, 2a which defines a geographical area in which competitor retail sites 3, 4, 5, 6 are considered to be direct competitors. That is, competitor sites 3, 4 which lie in region 1a are direct competitors of the first associated retail site 1 and competitor sites 5, 6 which lie in region 2a are direct competitors of the second associated retail site 2 such that sales of sites lying in region 1a affect sales of other sites lying in region 1a and sales of sites lying in region 2a affect sales of other sites lying in region 2a. It will be appreciated that a wider area such as a country will generally be divided into a plurality of regions in which retail sites compete with competitor sites. Regions may be selected based upon a geographical region such as an area surrounding a city or may be selected based upon other factors that determine competing sites such as sites located along a particular highway.

Associated retail fuel sites 1, 2 in the network of associated retail fuel sites may further be arranged in networks indicating groups of associated retail fuel sites that share a common pricing strategy such as retail fuel sites located at motorway service stations or retail fuel sites located in urban or rural areas. Additionally, associated retail fuel sites may be operated under various contract types and retail fuel sites operating under particular contract types may also be arranged into networks. Examples of contract types under which retail fuel sites may operate may include “company owned, company operated”, “company owned, franchisee operated”, “dealer owned, dealer operated” and “company owned, dealer operated”. The associated retail fuel sites and competitor retail fuel sites, networks and regions are used to construct a model defining interrelationships between associated retail fuel sites and competitor retail fuel sites. Where changes to the networks and regions subsequently occur, the model defining interrelationships between the sites is updated to reflect the changes.

A pricing system 7 is arranged to receive various data including data associated with each of the associated retail sites 1, 2 and data associated with competitor sites 3, 4, 5, 6. The pricing system 7 is arranged to process the received data and to generate various output data, in particular an optimal pricing strategy for each of the products at each of the associated retail sites 1, 2 based upon the provided information.

As described in detail below, the optimal price strategy is generated based upon various input data and provides an optimisation for profit from fuel sales for each associated retail fuel site. The input data includes site level volume constraints which indicate an amount of volume fuel sales which it is desirable to achieve for each associated retail fuel site. In prior art systems the site level volume constraints are typically based upon historical fuel sales. In the following description a general optimisation for profit from fuel sales at associated retail fuel sites will be described followed by a way in which profit from fuel sales can be optimised across a network of associated retail fuel sites. Methods for optimising total profit at associated retail fuel sites and across a network of associated retail fuel sites will then be described in which profit from sales other than fuel sales at the associated retail fuel sites is taken into account in the optimisation. The term total profit is to be understood as profit generated from all sales at a retail fuel site, including profit from fuel sales and profit from all other sales.

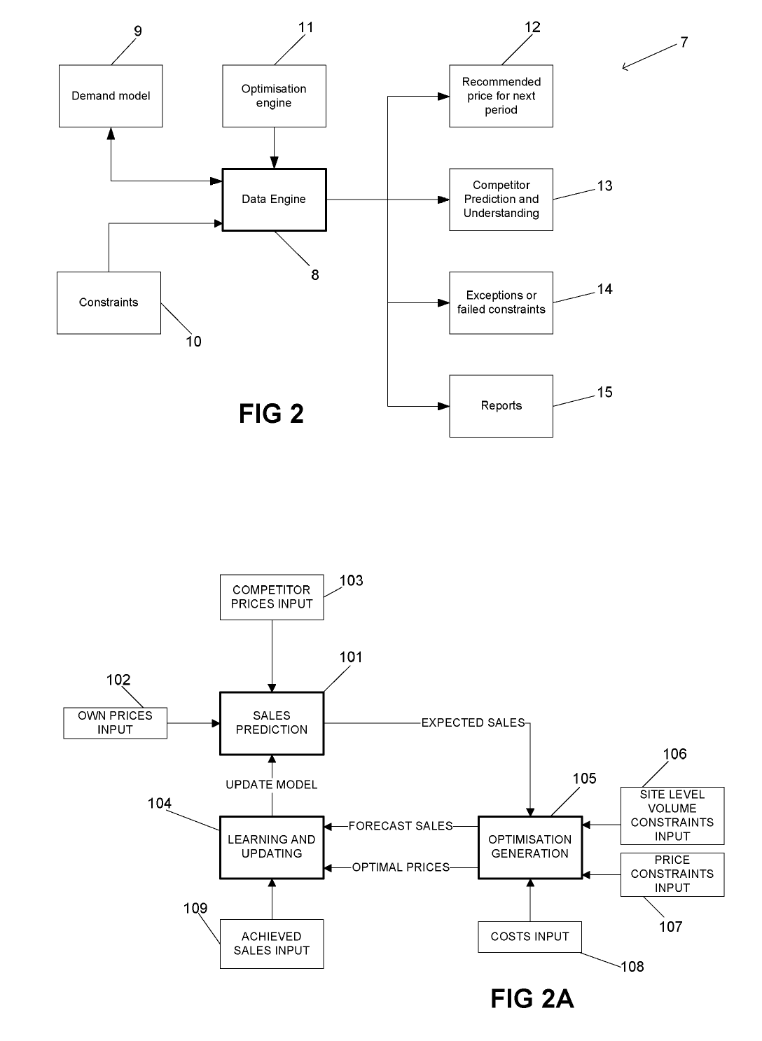

FIG. 2 shows operation of the pricing system 7 of FIG. 1 in more detail. It can be seen that the pricing system 7 takes various data as input, and generates various data as output as described above. Specifically, a data engine 8 takes as input a demand model 9 and constraints 10 and uses an optimisation engine 11. The demand model 9 forecasts sales volume for each product by site and time period. The demand model 9 uses past sales history at each site together with site prices and competitor site prices as well as elasticity values indicating sensitivity of customers to price changes for each product at each associated retail site 1, 2 and time period. The elasticity values provide an estimate of how demand for a particular product is likely to vary in response to price changes, either by an associated retail site 1, 2 or a competitor site 3, 4, 5, 6, and may be determined in an offline process using linear or non-linear regression modelling techniques based upon historic sales and price data. For example, stepwise or ridge regression may be used which are effective techniques for modelling historic price data which is generally highly correlated.

The retail site data and competitor site data may be provided to the pricing system 7 using a data link which automatically provides retail site data to the pricing system 7, for example at the end of each day. Competitor data is collected by the associated retail sites 1, 2 and provided to the pricing system 7 in any convenient way, for example by using the same data link as used to provide retail site data or alternatively using mobile computing devices which are used by operatives to collect the competitor data from the competitor site and which provide the competitor data to the pricing system 7 over wireless telecommunications. Alternatively, data may be provided in any convenient way. An example user interface suitable for inputting site and competitor prices is described below with reference to FIG. 4.

The constraints 10 allows a user to specify rules defining pricing strategies by site and/or product. The rules take the form of price differentials and ranges which it is desirable are satisfied by prices at an associated retail site 1, 2. Price differentials determine a pricing position of a site relative to other competitor sites within a region. Price differentials are used to indicate a range of acceptable prices for a particular product relative to corresponding competitor prices and the data engine 8 seeks to determine product prices which satisfy the specified price differentials. Price differentials may provide different ranges of acceptable prices relative to different competitors and in particular may include a differential relative to a main competitor and additionally or alternatively may include a differential relative to a different site in the network of associated retail fuel sites 1, 2, such that pricing at a first site in the network generally follows pricing at a second site in the network.

Price differentials may either be constraint-type differentials indicating constraints on prices that should be satisfied, often relative to a main competitor for a particular site, or guide-type differentials, which are optional constraints that are to be satisfied where possible, but which may be ignored if they cannot be met. Where a guide-type differential is not satisfied by pricing determined for a particular site, the site may be added to a list of sites to be manually reviewed, for example by an expert analyst or a manager at an associated retail fuel site 1, 2. Alternatively, rules may be relaxed either manually or automatically such that optimal prices can be determined. That is, where it is determined that all of the currently specified rules cannot be satisfied, one or more of the rules may be made less restrictive. The one or more rules may be selected based upon an order which specifies the order in which rules should be relaxed if all of the rules cannot be satisfied.

The optimisation engine 11 is used to determine a set of prices which maximise some objective, whilst attempting to satisfy the rules specified by the constraints 10. In general terms, price optimisation is concerned with balancing profit with volume sales within specified price constraints. The optimisation engine takes as input a policy which indicates the relative importance of profit and volume sales for the optimisation and may be provided as a value between 0 and 100 where 0 indicates that profit is to be maximised and 100 indicates that volume is to be maximised, and values between 0 and 100 indicate relative proportions of profit and volume maximisation. The optimisation engine 11 may additionally be provided with data indicating information about the current market environment which can be taken into account in the generation of prices such as, for example data indicating expected variation in sales in a region or network. Examples of additional information may include data indicating that an event caused a reduction of sales on a particular day, or that a forthcoming event is likely to cause high sales such that strategy should be modified, for example to maximise profit.

The data engine 8 uses the demand model 9, constraints 10 and optimisation engine 11 to generate a recommended price 12 for each product at each associated retail fuel site 1, 2 in the network of associated retail fuel sites using modelling techniques well known in the art. For example, sequential quadratic programming, active set solvers, interior point solvers or other suitable non-linear optimisation techniques may be used to generate the recommended price 12. Additionally, a daily error-correction process such as a Kalman filter or dynamic linear model may be used to update model parameters in light of prediction errors. The data engine 8 may additionally provide output data 13 which can be used to predict competitor price changes, and to understand competitor pricing policies. Data 14 is generated indicating constraints which are specified by the constraints 10 but which are not satisfied by the recommended price 12. Reports 15 may also be generated by the data engine 8. The output data may be provided to the associated retail site 1, 2 in any convenient way, for example using the same method as that used to provide retail site and competitor data to the pricing system 7 from the retail site.

Referring now to FIG. 2A, a schematic functional block diagram of the pricing system is shown. The system has three functional blocks 101, 104, 105 which each take data as input, from external sources and/or from others of the three functional blocks, and each generate output data.

In more detail, a sales prediction block 101 takes as input own prices 102 and competitor prices 103 together with an updated model generated at a learning and updating block 104, and outputs expected sales for the current period. The expected sales output from the sales prediction block 101 are input to an optimisation generation block 105 which also takes as input site level volume constraints 106 (indicating minimum required volume sales for a site), price constraints 107 and costs 108. The optimisation generation block processes its inputs and generates a set of optimal prices and a corresponding forecast of sales, the forecast of sales being based upon the generated set of optimal prices. The forecast of sales and the optimal prices output from the optimisation generation block 105 are input to the learning and updating block 104, together with achieved sales during the period for which the optimal prices were generated and used. The updated model that is passed to the sales prediction block 101 is generated at the learning and updating block 104 based upon the forecast sales for the period and the achieved sales for the period. In this way, the sales prediction for the next period is improved.

The optimal prices for an associated retail fuel site i, generated at the optimisation generation block 105 of FIG. 2A, can be determined by solving an optimisation problem of the form shown in equation (1):

$$maximise {\sum }_{i = 1}^{m} {\sum }_{k = 1}^{p} {G}_{tik} \qquad ( 1 )$$

with respect to own prices: {Pₜᵢₖ}_{i=1 . . . m,k=1 . . . p};
subject to price constraints: {gₗ_{ᵢₖ}≧0}ₗ_{ᵢₖ}_{=1 . . . q}_{ᵢₖ}_{,i=1 . . . m,k=1 . . . p}; and

site level volume constraints:

$${\{ {\sum }_{k} {V}_{tik} \geq {L}_{ti} \}}_{i = 1 … m}$$

where:
i is an index indicating an ith one of m associated retail fuel sites;
j is an index indicating a jth one of n competitor sites;
k is an index indicating a kth one of p fuel products;
t is a time period;
Gₜᵢₖ indicates gross profit from sale of grade k at site i in time period t and can be modelled in the form shown below in equation (3);
Pₜᵢₖ indicates the current price of fuel product k at associated retail fuel site i and time t;
lᵢₖ is an index indicating an lᵢₖth one of qᵢₖ price constraints indicating constraints on price such as a constraint on price difference between own and competitor products for a particular fuel product k;
gₗ_{ᵢₖ} models the qᵢₖ price constraints as a linear function of own price, cost and competing prices for site i and fuel product k and has the form shown in equation (4) below;
Vₜᵢₖ indicates sales volume in time period t at site i for grade k and can be modelled in the form shown below in equation (2); and
Lₜᵢ indicates a minimum volume target for sales in time period t at site i.

Sales volume can be modelled in the form shown in equation (2):

Vₜᵢₖ=f(Vₛᵢₖ,Pₜᵢₖ,Pₜⱼₖ) (2)

where:
Vₛᵢₖ indicates previous sales at a time s<t;
Pₜⱼₖ indicates the current price of fuel product k at competitor retail fuel site j and time t; and
f is a model describing the relationships (referred to as elasticities) between own prices and competitor prices, based upon previous sales Vₛᵢₖ and generally is a log-log or log-linear model. The coefficients of the price terms off are price elasticities. Further details of the form and estimation of the model can be found in, for example the following, which are herein incorporated by reference: Singh, M. G., Bennavail, J.-C, (1993) “Experiments in the use of a knowledge support system for the pricing of gasoline products”, Information & Decision Technologies 18(6): 427-442; Krasteva, E., Singh, M. G., Sotirov, G., Bennavail, J.-C., and Mincoff, N., (1994) “Model Building for pricing decision making in an uncertain environment, Proc. IEEE International Conference on Systems, Man and Cybernetics”, San Antonio; and Bitran, G., Caldentey, R. and Mondeschein, S. (1998) “Coordinating clearance markdown sales of seasonal products in retail chains”, Operations Research 46(5): 609-624.

Accordingly gross profit Gₜᵢₖ can be modelled as shown in equation (3):

$${G}_{tik} = ( \frac{{P}_{tik}}{1 + v} - {C}_{tik} ) {V}_{tik} = ( \frac{{P}_{tik}}{1 + v} - {C}_{tik} ) f ( {V}_{sik} , {P}_{tik} , {P}_{tjk} ) \qquad ( 3 )$$

where:
Pₜᵢₖ indicates current price of fuel product k at site i and time t as above;
Cₜᵢₖ indicates direct sales costs for fuel product k in time period t at site i; and
v is the applicable sales tax rate.

The price constraints gₗ_{ᵢₖ} can be modelled in the form shown in equation (4):

gₗ_{ᵢₖ}(Pₜᵢₖ,Cₜᵢₖ,Pₜⱼₖ)≧0 (4)

where Pₜᵢₖ, Cₜᵢₖ and Pₜⱼₖ are as described above.

The optimisation problem of equation (1) can be solved using non-linear optimisation techniques well known in the art such as those described in Gill, P. E., Murray, W., and Wright, M. H., “Practical Optimisation” (1981), Academic Press, which is herein incorporated by reference. The optimisation provides a set of prices Pₜᵢₖ, indicating an optimal price at each site for each fuel product given various constraints that are applicable at the current time t.

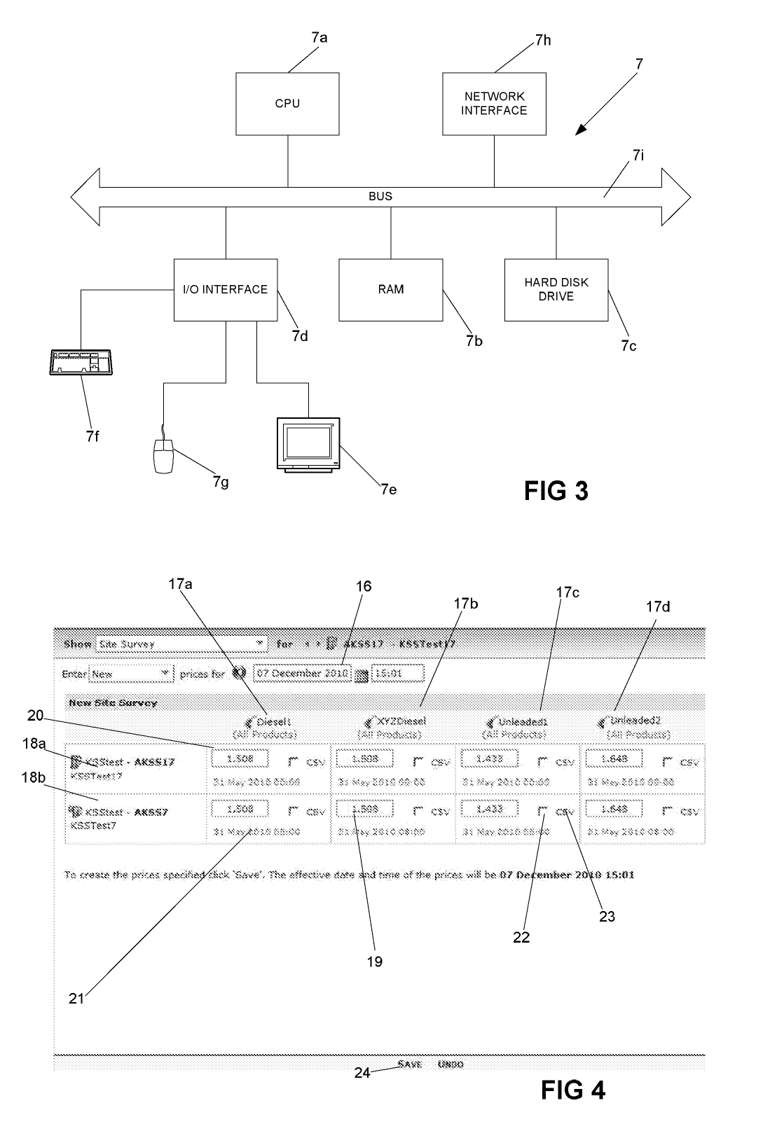

FIG. 3 shows a computer associated with the pricing system 7 of the system of FIG. 1 in further detail. It can be seen that the computer associated with the pricing system comprises a CPU 7a which is configured to read and execute instructions stored in a volatile memory 7b which takes the form of a random access memory. The volatile memory 7b stores instructions for execution by the CPU 7a and data used by those instructions. For example, in use, software used to determine optimal prices for retail fuel sites may be stored in volatile memory 7b.

The computer associated with the pricing system 7 further comprises non-volatile storage in the form of a hard disc drive 7c. Data such as retail fuel site data and competitor site data may be stored in the hard disc drive 7c. The computer associated with the pricing system 7 further comprises an I/O interface 7d to which are connected peripheral devices used in connection with the computer associated with the pricing system 7. The computer associated with the pricing system 7 has a display 7e configured so as to display output from the data engine. Input devices are also connected to the I/O interface 7d. Such input devices include a keyboard 7f, and a mouse 7g which allow user interaction with the data engine. A network interface 7h allows the computer associated with the pricing system 7 to be connected to an appropriate computer network so as to receive and transmit data from and to other computing devices such as computing devices provided at the retail fuel sites. The CPU 7a, volatile memory 7b, hard disc drive 7c, I/O interface 7d, and network interface 7h, are connected together by a bus 7i.

It has been indicated above that associated retail fuel site and competitor site prices are provided to the pricing system 7. Referring to FIG. 4, a user interface suitable for inputting product prices for a site and its competitors is shown. The time and date for which the data applies is provided using date and time fields 16. Headers 17a, 17b, 17c and 17d indicate different products available at the site for which data is to be entered. A row 18a provides data display and entry for an associated retail fuel site “AKSS17” and a row 18b provides data entry and display for a competitor retail fuel site. Other rows may be provided to provide data entry and display for further competitor retail fuel sites, as determined from the model defining interrelationships between the sites.

Price fields 19, 20 provide editable fields in which price data associated with each product and site is entered and/or displayed. For example, price field 19 provides a field in which price data for product “Diesel1” at site “AKSS7” is entered and displayed and price field 20 provides a field in which price data for product “XYZDiesel” at site “AKSS17” is entered and displayed. Price fields 19, 20 may be provided with associated logic which defines maximum and minimum values. Each price field 19, 20 has an associated time and date stamp 21 which indicates the time and date of the last change to the price displayed in the time and date field. A check box 22 associated with each price field 19, 20 allows a user of the user interface to select whether the input data should be updated in the pricing system 7 and a price entry marker 23 associated with each price field 19, 20 indicates the source of the displayed value. The source of the displayed value may be one of user entered, entered following site survey, file input, entered via error browser or set by pricing system. Upon selection of a “save” button 24 data that has been entered into the user interface is submitted to the data engine, and in particular values in the demand model are updated.

In some embodiments the output data may be used to cause automatic update of optimal fuel prices at the associated retail fuel sites 1, 2, for example by providing data to a computer located at the associated retail fuel sites 1, 2 which is in communication with pumps, tills and signage at the associated retail fuel sites. Where automatic update of optimal fuel prices is used, it is generally necessary to carry out the update at a time when the associated retail fuel sites 1, 2 are not operational. However in general output data is provided to the associated retail fuel sites 1, 2 and fuel prices are changed by way of at least some manual intervention. For example, a manager of each associated retail fuel site 1, 2 may receive at least some of the output data generated by the pricing system 7 and may then decide what fuel price changes to implement.

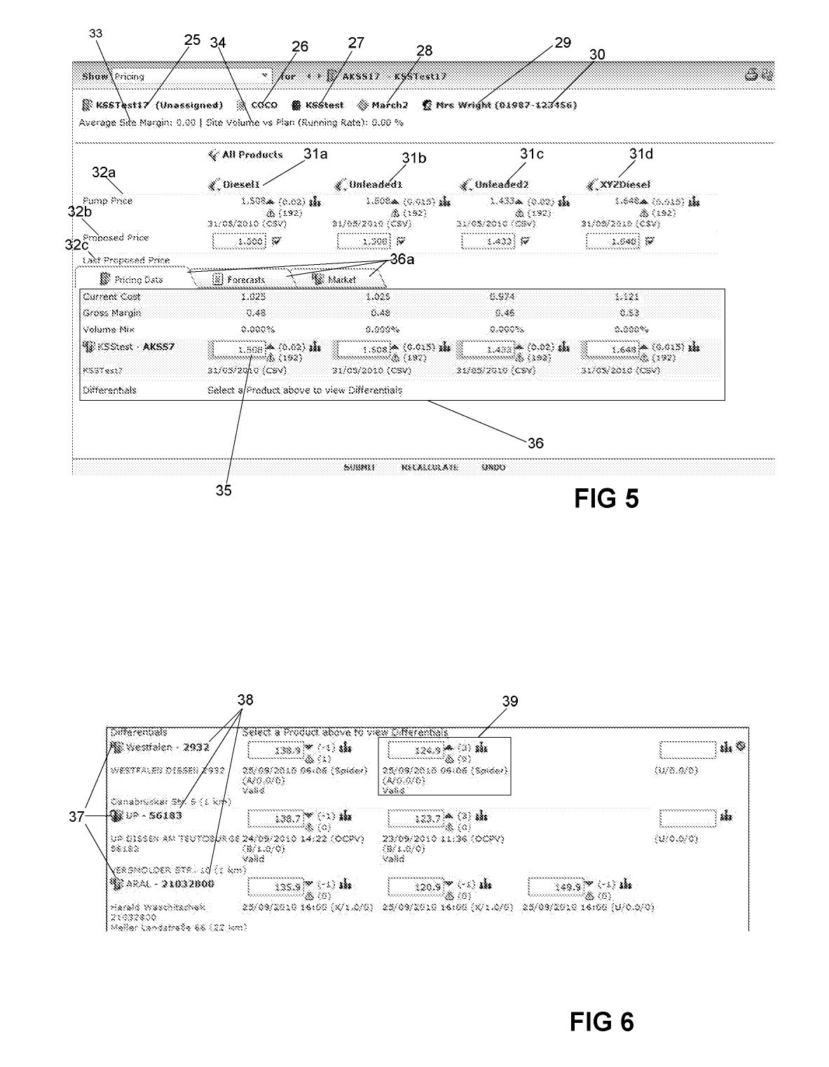

As indicated above, various output data relevant to each site is generated and provided to associated retail fuel sites 1, 2. The output data provided to each site may be displayed on a pricing page which provides data relevant to the particular retail fuel site such as the pricing page of FIG. 5. For example, the pricing page may display site details including the name of the site 25, contract type 26, brand 27, area 28, area manager name 29 and contact number 30 associated with the retail fuel site. Headers 31a, 31b, 31c and 31d indicate different products available at the site and data relevant to each product is displayed in columns beneath each header. The data relevant to each product includes pump price data displayed in a row indicated by header 32a which is described in further detail below with reference to FIG. 6, a proposed price field displayed in a row indicated by header 32b which includes an editable price field into which price changes can be entered and a check box which indicates whether an entered price should be updated in the pricing system 7, and a last proposed price displayed in a row indicated by header 32c. Average site margin 33 indicating the average margin across all fuel products at the site is displayed, together with an indication 34 of the percentage running rate indicating the percentage of planned target sales volume in the current planning period that have actually been achieved, where the planned target sales volume is calculated by multiplying the total target sales volume in the current planning period by the proportion of time that has passed in the current planning period.

Additionally, tabs 36a allow a user to selectively display one of further pricing data, forecasts and market data in screen area 36. In FIG. 5 the pricing data tab is selected such that further pricing data is shown. Selection of the forecasts tab of the tabs 36a causes screen area 36 to display calculated forecast values for each of volume, profit and profit per unit volume for each product based upon the current proposed price for each product together with a change relative to a previous forecast for each of the forecasts. Selection of the market tab of the tabs 36a causes pricing details of competitor sites to be displayed for each product sold at both the current site (as indicated by the name of the site 25) and competitor sites.

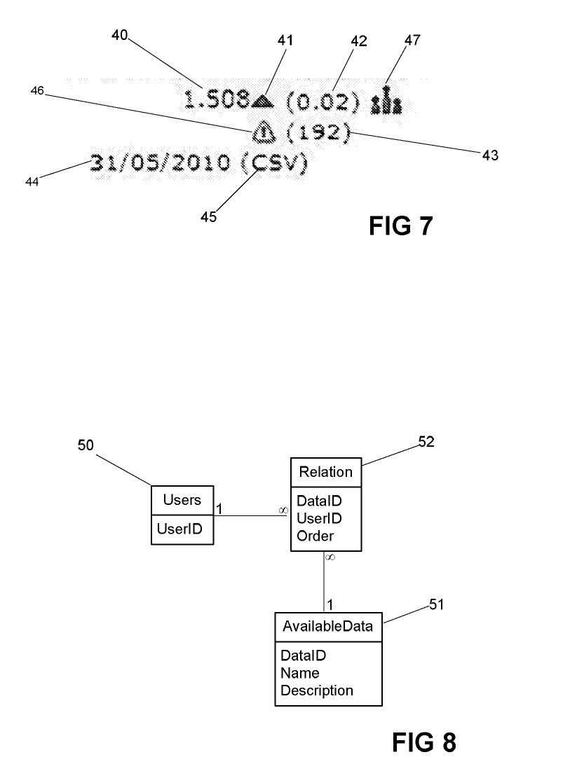

An example pump price data displayed for product “Diesel1” of FIG. 5 is shown in FIG. 7. It will be appreciated that competitor pump price data displayed upon selection of the market tab has the same form. The pump price data includes a current pump price 40 and a price movement indicator 41 which indicates whether the current pump price 40 is higher, lower or equal to the previous pump price. The difference 42 between the current pump price 40 and the previous pump price is also indicated together with the number of days 43 since the last price change. Date stamp 44 indicates the date that the current pump price was last modified and a source stamp 45 indicates how the current pump price was modified such as user entered, entered following site survey, file input, entered via an error browser or set by pricing system. Additionally an icon 46 may be provided to indicate one or all of: the displayed price has not been updated within a predetermined number of days; the displayed price was amended by a user other than the current user; the displayed competitor price is not active, that is, the displayed competitor price is excluded from processing, for example due it not having been validated; the displayed competitor price has been verified by a third party source; and the displayed competitor price cannot be verified by a third part source. Where it is indicated that the displayed competitor price cannot be verified by a third party source, a check box may be displayed which allows a user to verify the price manually. Selection of an icon 47 causes a chart of historic price data and/or sales volume data to be displayed for the relevant item.

The pricing page is configurable such that information may be displayed to a user according to predefined preferences for that user. The predefined preferences may be selected by the user or may be selected for each user on the basis of a property of the user, such as for example the contract type for a retail fuel site associated with the user. In this way, the information that is most relevant and/or useful to the user is provided. The pricing page shows a layout that corresponds to the pricing page and allows types of data to be specified in areas of the layout for a particular user such that the specified data is displayed in corresponding areas of the pricing page that is displayed to the user. Further details of the pricing page can be found in applicant's co-pending United States patent application filed 28 Jan. 2011 with filing No. 13/016,378, which is herein incorporated by reference.

Various data can be configured to be displayed within screen areas of the pricing page. For example, site details such as a rolling run rate indicating a total achieved volume sales as a percentage of total volume over weighted planning periods, may be displayed in addition to or in place of, for example, percentage running rate 34 shown in FIG. 5. Examples of data that may be displayed in area 36 shown in FIG. 5 in addition to or in place of one or more of the current cost, gross margin, volume mix and price differentials shown in FIG. 5 include: an average competitor price indicating the average price for each product across all competitor sites; a card price indicating the pump price minus a specified discount value; competitor data showing details of competitor sites; a delivery cost indicating a total cost associated with delivering a unit of each fuel product to a customer; a future price indicating details of prices that are to be applied at a predetermined time in the future; like for like volumes indicating volume sales for each product over a predetermined time period as a percentage of volume sales for the product over the same time period in a previous year; a policy for each product indicating a volume sales target for the product; and superseded prices indicating details of prices that have been replaced. The future price for each product may include details of a price to be applied at a time in the future, the time at which the price is applicable and data associated with the origin of the price. Similar details may be provided for superseded prices. It will be appreciated that any other suitable screen area and data field may be configured to either be displayed or to not be displayed, in order to configure the pricing page to different users' requirements.

Data associated with the display of data on a pricing page for users may be stored in any convenient form. For example, FIG. 8 is an entity diagram of a database suitable for storing and managing data to be displayed as part of a pricing page for different users. As shown in FIG. 8, the database has three tables: a Users table 50; an AvailableData table 51 and a Relation table 52. Each entry of the Users table 50 is associated with a user of the system, each entry of the AvailableData table 51 is associated with a data item that may be displayed as part of a pricing page and each entry of the Relation table 52 indicates a relationship between a user and a data item, together with an order associated with display of the data item.

The Users table 50 has a UserID field which is its primary key, and may additionally have fields for storing data associated with each user such as a name field. The AvailableData table 51 has a dataID field which is its primary key, a Name field for storing the name of a data item and a Description field for storing a description of the data item. The Relation table 52 has a DataID field which identifies a record of the AvailableData table 51, a UserID field which identifies a record of the Users table 50 and an Order field which defines an order for display of the data item identified by the DataID field relative to other data items to be displayed.

When a pricing page is to be displayed for a particular user a lookup is carried out to identify all records of the Relation table 52 having a UserID corresponding to the UserID of the particular user.

The DataID of each identified record identifies a record of the AvailableData table 61 which corresponds to a data item to be displayed as part of the pricing page which can then be displayed to the user.

In the optimisation of equations (1) to (4), where two associated retail sites i, j are indicated as sites whose sales affect each other then pricing changes at retail site i will impact sales at retail site j and vice versa. Similarly, if a price constraint on a product at an associated retail site i depends on the value of a price for the product on an associated retail site j, prices at sites i and j will also be interdependent. These cases are, however, exceptional, and in general profit is maximised for each associated retail site independently of other ones of the m associated retail sites by providing a set of optimal prices for each site which satisfy the set of constraints for that site, and in particular that satisfies the site level volume constraint Lₜᵢ for that site. It is desirable to maximise profit across the network of associated retail sites.

In existing systems the site level volume constraints Lₜᵢ for each associated retail site i are set for each site independently of other associated retail sites, generally using actual volume sales from the previous month at that site and possibly varying positively or negatively by a percentage of the previous month actual volume sales. However, site level volume constraints Lₜᵢ can be set in such a way that total network volume sales are maintained and such that profit across the whole network of associated retail fuel sites is therefore optimised, as will now be described.

In general terms, the optimisation for profit across the network comprises a first stage in which average prices and costs across a recent time period are used to determine an optimal set of site level volume constraints, and those determined site level volume constraints are subsequently used in the optimisation described above.

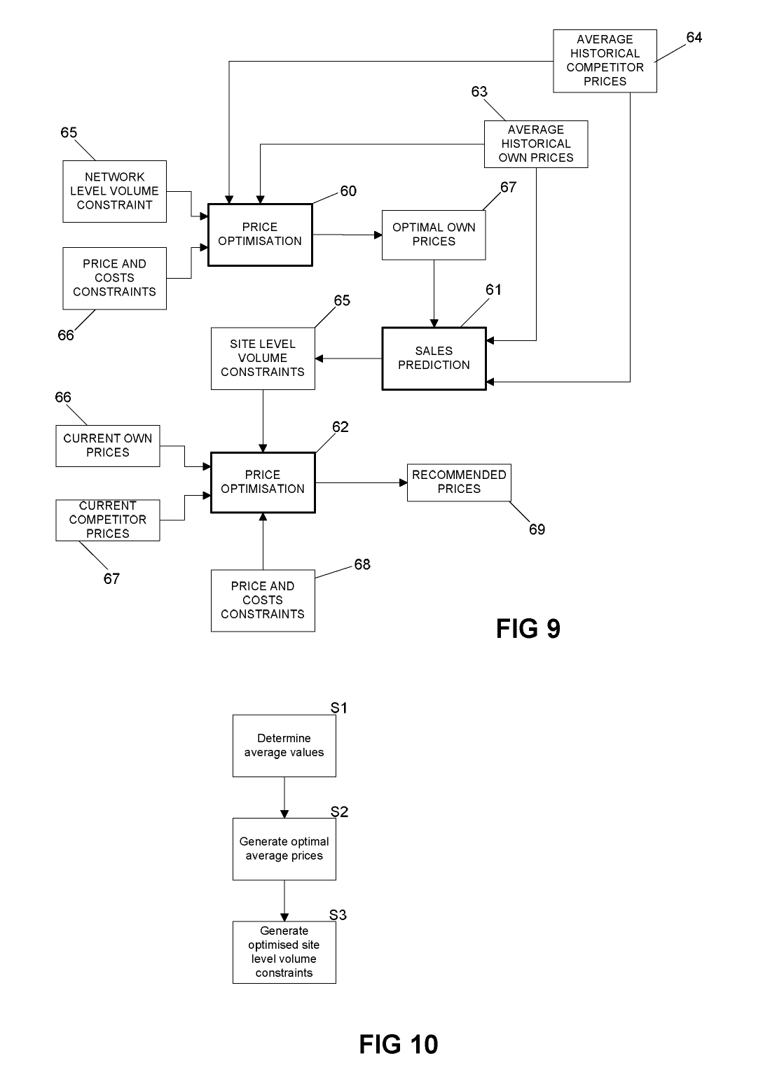

Referring to FIG. 9, a schematic functional block diagram of a pricing system for generating prices that are optimal across a network is shown. The system has a first price optimisation block 60, a sales prediction block 61, and a second price optimisation block 62. The functional blocks 60, 61, 62 take data as input, from both external sources and additionally from others of the three functional blocks, and each generate output data.

In more detail, the first price optimisation block 60 takes as input average historical own prices 63 (i.e. an average price from a recent time period for each product and associated retail site), average historical competitor prices 64, a network level volume constraint 65 and price and costs constraints 66 and generates a set of optimal own prices 67, for example according to the optimisation of equations (5) to (8). The set of optimal own prices 67 include a price for each product at each associated retail site. The set of optimal own prices 67 are input into the sales prediction block 61 together with the average historical own prices 63 and average historical competitor prices 64. The sales prediction block 61 processes its inputs and generates a set of site level volume constraints 65, with one site level volume constraint for each of the plurality of associated retail fuel sites.

The site level volume constraints are therefore generated by first generating prices with only the total sales across the network of associated retail fuel sites constrained, and those prices are used to generate volume constraints for each site.

The site level volume constraints 65 are input to the second price optimisation block 62 which additionally takes as input current own prices 66, current competitor prices 67 and price and costs constraints 68, which are in general the same as the price and costs constraints 66. The second price optimisation block 62 generates a set of recommended prices 69 for each of the associated retail fuel sites and may be, for example, as described above with reference to FIG. 2A.

FIG. 10 shows processing carried out by the functional blocks 60, 61, 62 of FIG. 9 to generate optimised site level volume constraints which can be used to determine a set of prices that provide an optimisation for profit across a network of associated retail sites at a high level. At step S1 average competitor prices for each competitor site and product, P̅ₜⱼₖ, and average costs for each associated retail fuel site and product, C̅ₜᵢₖ, are determined over a recent time period t, for example over the preceding two weeks.

At step S2 a set of average own prices P̅ₜᵢₖ which maximise average gross profit G̅ₜᵢₖ is determined by solving an optimisation problem of the form shown in equation (5):

$$maximise {\sum }_{i = 1}^{m} {\sum }_{k = 1}^{p} {\overline{G}}_{tik} \qquad ( 5 )$$

with respect to average own prices: { P̅ₜᵢₖ}_{i=1 . . . m,k=1 . . . p};
subject to price constraints: { g̅ₗ_{ᵢₖ}≧0}ₗ_{ᵢₖ}_{=1 . . . q}_{ᵢₖ}_{,i=1 . . . m,k=1 . . . p}; and
network volume constraint:

$${\sum }_{i} {\sum }_{k} {\overline{V}}_{tik} \geq {\overline{L}}_{t}$$

where:
i is an index indicating an ith one of m associated retail fuel sites;
j is an index indicating a jth one of n competitor sites;
k is an index indicating a kth one of p fuel products;
l is the recent time period over which competitor prices and costs are averaged;
G̅ₜᵢₖ indicates average gross profit from sale of grade k at site i in time period t and can be modelled in the form shown below in equation (7);
P̅ₜᵢₖ indicates average price of fuel product k at associated retail fuel site i in time t; is an index indicating an lᵢₖth one of qᵢₖ price constraints indicating constraints on price such as a constraint on price difference between own and competitor products for a particular fuel product k;
g̅ₗ_{ᵢₖ} models the qᵢₖ price constraints as a linear function of own price, cost and competing prices for site i and fuel product k and has the form shown in equation (8) below;
V̅ₜᵢₖ indicates average sales volume in time period t at site i for grade k and can be modelled in the form shown below in equation (6); and
L̅ₜ indicates a minimum volume target for sales in time period t across the network of associated retail fuel sites.

Average sales volume can be modelled in the form shown in equation (6):

V̅ₜᵢₖ=f(Vₛᵢₖ, P̅ₜᵢₖ, P̅ₜⱼₖ) (6)

where:
Vₛᵢₖ indicates previous sales at a time s before time period t;
P̅ₜⱼₖ indicates average price of fuel product k at competitor retail fuel site j during time period t; and
f is a model describing the elasticities between own prices and competitor prices, based upon previous sales Vₛᵢₖ as in equation (2).

Gross profit G̅ₜᵢₖ can be modelled in a corresponding manner to equation (3), as shown in equation (7):

$${\overline{G}}_{tik} = ( \frac{{\overline{P}}_{tik}}{1 + v} - {\overline{C}}_{tik} ) {\overline{V}}_{tik} = ( \frac{{\overline{P}}_{tik}}{1 + v} - {\overline{C}}_{tik} ) f ( {V}_{sik} , {\overline{P}}_{tik} , {\overline{P}}_{tjk} ) \qquad ( 7 )$$

where:
P̅ₜᵢₖ indicates average price of fuel product k at site i during time t as above;
C̅ₜᵢₖ indicates average direct sales costs for fuel product k during time period t at site i; and
v is the applicable sales tax rate.

The price constraints g̅ₗ_{ᵢₖ} can be modelled in a corresponding manner to equation (4), as shown in equation (8):

g̅ₗ_{ᵢₖ}( P̅ₜᵢₖ, C̅ₜᵢₖ, P̅ₜⱼₖ) (8)

where P̅ₜᵢₖ, C̅ₜᵢₖ and P̅ₜⱼₖ are as described above. The price constraints g̅ₗ_{ᵢₖ} will, in general, be the same as the price constraints g but are applied to different data, with the price constraints g̅ₗ_{ᵢₖ} being applied to average price and cost values and the price constraints gₗ_{ᵢₖ} being applied to current price and cost values.

It can be seen that the optimisation of equations (5) to (8) generally corresponds to the optimisation of equations (1) to (4). However, the optimisation of equations (5) to (8) uses as input average values over a predetermined time period, for example average competitor prices P̅ₜⱼₖ and average costs C̅ₜᵢₖ, and generates a set of optimal average own prices { P̅ₜᵢₖ}_{i=1 . . . m,k=1 . . . p}. Additionally, the optimisation of equations (5) to (8) has a volume sales constraint that is set at a network level, as compared to the site level volume sales constraints of the optimisation of equations (1) to (4). As such, average prices at each site are not restricted by site level sales constraints and can move freely within the range provided by the price constraints.

The set of optimal average own prices { P̅ₜᵢₖ}_{i=1 . . . m,k=1 . . . p} determined at step S2 are processed at step S3 to generate optimised site level volume constraints. In particular, replacing P̅ₜᵢₖ with P̅ₜᵢₖ in equation (6) allows an optimised volume sales V̅ₜᵢₖ to be determined for each product k at each site i for the period t, given that each of Vₛᵢₖ and P̅ₜⱼₖ are known. Optimised site level volume constraints L̅ₜᵢ are determined from the optimised volume sales V̅ₜᵢₖ according to equation (9) below.

$${\overline{L}}_{ti} = {\sum }_{k} {\overline{\overline{V}}}_{tik} \qquad ( 9 )$$

The network level volume constraint L̅ₜ used in equation (5) is generally determined by summing non-optimised site level volume constraints. That is,

$${\overline{L}}_{t} = {\sum }_{i} {L}_{ti} ,$$

where Lₜᵢ is the non-optimised site level volume constraint for site i, such as the site level volume constraints used in the optimisation of equation (1). Where the network volume constraint of equation (5) is satisfied, that is, where

$${\sum }_{i} {\sum }_{k} {\overline{V}}_{tik} = {\overline{L}}_{t}$$

for the set of optimal average own prices { P̅ₜᵢₖ}_{i=1 . . . m,k=1 . . . p}, which is generally the case, then

$${\sum }_{i} {\overline{L}}_{ti} = {\sum }_{i} {L}_{ti}$$

and as such the total network volume target is not changed by the network volume sales optimisation. Rather, site level volume target sales are transferred from sites where relatively low profit can be achieved to sites where relatively high profit can be achieved. Optimised site level volume constraints are generated periodically, for example monthly or fortnightly, based upon average values from a previous recent period. Because site level volume target sales are set for a time period t, planning of distribution and storage of fuel is improved. Furthermore use of average values from a recent period in the generation of optimised site level volume targets in this way provides robustness to market fluctuations.

A set of prices can be generated according to the optimisation of equations (1) to (4) using the optimised site level volume constraints L̅ₜᵢ in place of the site level volume constraints Lₜᵢ of equation (1). The optimised site level volume constraints are used in the optimisation of equation (1) whenever prices are determined according to the optimisation of equation (1), in general whenever input data such as competitor prices is updated, generally daily, until a new set of optimised site level volume constraints are generated. By determining prices using optimised site level volume constraints, profit is optimised across the network whilst site level price changes at an associated retail fuel site caused by price changes at a competitor site that is not a direct competitor of the associated retail fuel site are minimised.

The above optimisations provide prices which optimise profit from fuel sales at a plurality of associated retail fuel sites. However, associated retail fuel sites will in general additionally sell products and/or services other than fuel such as, for example, groceries and car cleaning services, which also generates profit. Profit generated from sales other than fuel sales (herein referred to as “store sales”) will typically vary across a network of associated retail fuel sites, with some retail fuel sites generating a relatively large amount of store sales for each unit of fuel sales, and other sites generating a relatively small amount of store sales for each unit of fuel sales. As such it is desirable to optimise total profit including profit from fuel and profit from store sales. Methods for optimising total profit will now be described.

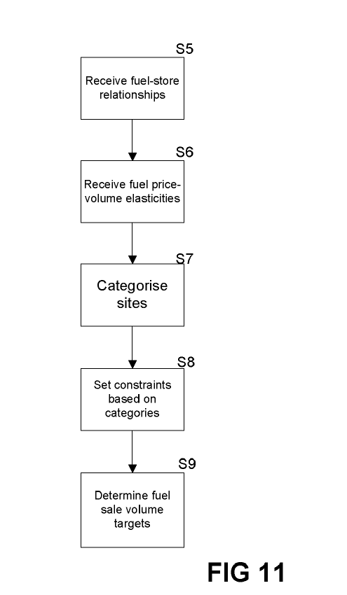

Referring to FIG. 11, processing to optimise total profit across a network is shown. At step S5 fuel-store relationships Fₜᵢ are received. The fuel-store relationships Fₜᵢ are generated based upon historical daily sales totals for fuel and store, and indicate the relationship between fuel sales and store sales at each store. The fuel-store relationships generally take the form of a value indicating the amount of store sales for each gallon of fuel purchased at the retail fuel site. Whilst the fuel-store relationship is determined based upon historical daily sales totals for fuel and store, it can be seen that the fuel-store relationship is composed of three factors: an average store spend per store customer; a percentage of fuel customers that make a store purchase; and the number of fuel customers per gallon of fuel sold. That is, the value Fₜᵢ=(average store spend per store customer)×(percentage of fuel customers that make a store purchase)×(number of fuel customers per gallon of fuel sold). Average store spend per store customer and number of fuel customers per gallon of fuel sold can be estimated based upon historical store and fuel sale data in a straightforward manner, and it is therefore possible to estimate the percentage of fuel customers that make a store purchase based upon the values for Fₜᵢ, average store spend per store customer and number of fuel customers per gallon fuel sold. The percentage of fuel customers that make a store purchase can be used in modelling the impact of changes, as described below.

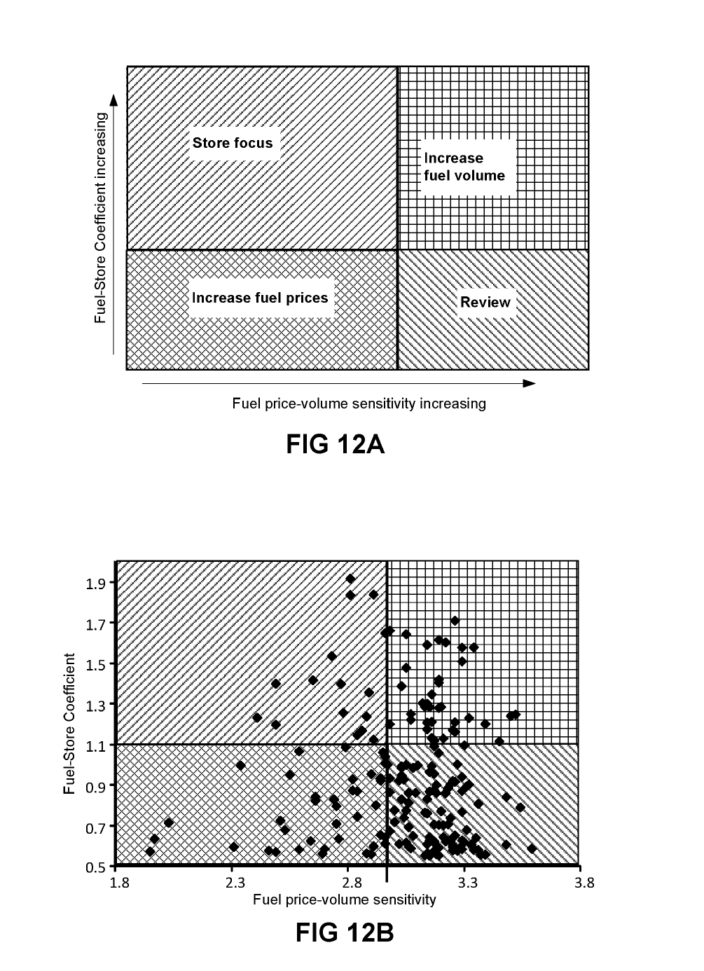

At step S6 fuel price-volume elasticities are received. The fuel price-volume elasticities provide an indication of the percentage change in fuel volume resulting from a particular percentage change in fuel price at each site and can be determined based upon historical data. At step S7 the fuel-store relationships and fuel price-volume elasticities received at steps S5 and S6 respectively are processed to generate a categorisation for each of the associated retail fuel sites. Categorisations of retail fuel sites are described in detail below with reference to FIGS. 12A and 12B. At step S8 price constraints for the retail fuel sites g̅ₗ_{ᵢₖ} are set based upon the categorisations determined at step S7 and at step S9 fuel sale volume targets are determined by solving an optimisation problem based upon the optimisation problem of equation (5) and modified to include store profit as shown in equation (10) below.

$$maximise ( {\sum }_{i = 1}^{m} {\sum }_{k = 1}^{p} {\overline{G}}_{tik} + {\sum }_{i = 1}^{m} {\overline{S}}_{ti} ) \qquad ( 10 )$$

with respect to average own prices: { P̅ₜᵢₖ}_{i=1 . . . m,k=1 . . . p};
subject to price constraints: { g̅ₗ_{ᵢₖ}≧0}ₗ_{ᵢₖ}_{=1,i=1 . . . m,k=1 . . . p}; and
network volume constraint:

$${\sum }_{i} {\sum }_{k} {\overline{V}}_{tik} \geq {\overline{L}}_{t}$$

where:
S̅ₜᵢ indicates average gross profit from store sales at site i in time period t and can be modelled together with G̅ₜᵢₖ as shown in equations (11) and (12) below. All other terms are the same as for equation (5).
S̅ₜᵢ and G̅ₜᵢₖ can be modelled by modifying equation (7) as shown in equation (11):

$${\overline{G}}_{tik} + {\overline{S}}_{ti} = ( \frac{{\overline{P}}_{tik}}{1 + v} - {\tilde{C}}_{tik} ) f ( {V}_{sik} , {\overline{P}}_{tik} , {\overline{P}}_{tjk} ) \qquad ( 11 )$$

where:
\tilde{C}ₜᵢₖ is a modified cost function of the form shown in equation (12):

\tilde{C}ₜᵢₖ= C̅ₜᵢₖ−MₜᵢFₜᵢ (12)

where:
Mₜᵢ is the store margin at store i in time t indicating a percentage value of sales which is profit and Fₜᵢ is the fuel-store relationship received at step S5 such that MₜᵢFₜᵢ is the profit generated in store per unit volume fuel sale of any grade. All other terms in equation (11) are the same as in equation (7).

By modifying the cost function of equation (7) as set out in equations (11) and (12) the profit generated from store sales is effectively used to offset the costs associated with fuel sales and the optimisation problem of equation (7) can be modified to include store sales with minimal changes to the optimisation problem. In particular, as described above with reference to the optimisation of equation (5), the optimisation of equation (10) is used to generate optimal prices for each retail fuel site which are processed to determine optimal fuel sales volume constraints for each retail fuel site.

It is indicated above that associated retail fuel sites are categorised at step S7 based upon the fuel-store relationships and fuel price-volume elasticities received at steps S5 and S6. Each of the associated retail fuel sites is categorised as one of “store focus”, “increase fuel volume”, “increase fuel prices” and “review” based upon the relationship between fuel-store coefficient and price-volume sensitivity, as shown in FIG. 12A. In particular, those retail fuel sites having a relatively high fuel-store coefficient and a relatively high fuel price-volume sensitivity are classified as “increase fuel volume”, those stores having a relatively low fuel-store coefficient and a relatively low fuel price-volume sensitivity are classified as “increase fuel prices”, those stores having a relatively high fuel-store coefficient and a relatively low fuel price-volume sensitivity are classified as “store focus” and those stores having a relatively low fuel-store coefficient and a relatively high fuel price-volume sensitivity are classified as “review”. The classifications of retail fuel sites are described below.

FIG. 12B shows a plurality of retail fuel sites plotted on a graph indicating the relationship between fuel-store coefficient and fuel price-volume sensitivity, where each point indicates a retail fuel site of a plurality of associated retail fuel sites. The categorisation of the retail fuel site may be determined for example by generating such a plot or using one or more threshold values for the fuel-store coefficient and fuel price-volume sensitivity. Any retail fuel sites that fall near a boundary between two or more categories may be reviewed by a user to determine which category for the site is most appropriate.

As indicated above, the categorisations are used to set fuel price constraints for retail fuel sites. In general terms the price constraints take the form of price differentials. Price differentials for those stores categorised as “increase fuel prices” are increased such that fuel prices are allowed to be high relative to competitor sites. This is because fuel sales at sites categorised as “increase fuel prices” are relatively insensitive to price given that these sites each have a low fuel price-volume sensitivity, and additionally any decrease in fuel sales at those sites will have a relatively small effect on fuel store profit given the relatively low fuel-store coefficient of those sites. Price differentials for those stores categorised as “increase fuel volume” are set such that fuel prices at those sites are low relative to competitor sites. This is because fuel sales at sites categorised as “increase fuel volume” are relatively sensitive to price given that these sites each have a high price-volume sensitivity. As such, reducing prices at these sites will increase fuel sale volume. Additionally, given that these sites have a relatively high fuel-store coefficient increased fuel sale volume will increase store profit offsetting any reduction in profit from fuel sales caused by reduced fuel prices.

Fuel sales at sites categorised as “store focus” are relatively insensitive to fuel price changes, however any negative effect on fuel sales caused by fuel price increases are likely to be offset by a relatively large negative effect on store sales. Store sales at sites categorised as store focus may be improved by, for example, modifying store layout or the range of products available at the store. Such changes may enable any negative impact on stores sales that a fuel price increase has to be mitigated, or may allow greater revenue to be generated from the current store customers. Fuel sales at sites categorised as “review” are relatively sensitive to fuel price changes, however any positive effect on fuel sales caused by fuel price decreases are likely to have little effect on store sales. As such, retail fuel sites in these two categories may be reviewed on a per site basis to determine whether any changes to price constraints are desirable, however in general sites in these two categories do not particularly benefit from price constraint adjustments.

The fuel sale volume targets generated at step S9 of FIG. 11 are used in an optimisation to generate optimal prices at each retail fuel site. The optimisation may take the form of the optimisation of equation (1) or the optimisation of equation (1) may be modified in a corresponding manner to the modification made to equation (5) to introduce store sales, as shown in equation (13) below, with total profit generated in a corresponding manner to that shown in equations (11) and (12) above.

$$maximise ( {\sum }_{i = 1}^{m} {\sum }_{k = 1}^{p} {G}_{tik} + {\sum }_{i = 1}^{m} {S}_{ti} ) \qquad ( 13 )$$

with respect to own prices: { P̅ₜᵢₖ}_{i=1 . . . m,k=1 . . . p};
subject to price constraints: {gₗ_{ᵢ}≧0}ₗ_{ᵢₖ}_{=1 . . . q}_{ᵢₖ}_{,i=1 . . . m,k=1 . . . p}; and
site level volume constraints:

$${\{ {\sum }_{k} {V}_{tik} \geq {L}_{ti} \}}_{i = 1 … m} .$$

It has been described above that various data relating to both fuel sales and store sales at associated retail fuel sites is received and processed to determine optimal fuel sales targets for the associated retail fuel sites, and that the optimal fuel sales targets are processed to determine an optimal set of fuel prices for the associated retail fuel sites. However it will be appreciated that it may be possible to modify some of the received data. For example, it may be possible to influence the fuel-store coefficient at some or all of the associated retail fuel sites, for example by running in-store promotions which increase the percentage of customers who make a store purchase and therefore modify the fuel-store coefficient by the relationship Fₜᵢ=(average store spend per store customer)×(percentage of fuel customers that make a store purchase)×(number of fuel customers per gallon of fuel sold) described above. Such a promotion may additionally affect store sales margin such that it is difficult to determine whether such a change is likely to increase total site sales profit or decrease total site sales profit. It may additionally be possible to influence elasticities with competitors, for example by changing fuel types sold at a particular associated retail fuel site. Furthermore it is possible to modify fuel margins, for example by reducing fuel prices. As is apparent from the above description, some or all of these possible changes have a complex relationship with other values and as such it is desirable to be able to model possible retail fuel site scenarios such that optimal values can be determined Methods and interfaces for modelling possible retail fuel site scenarios will now be described.

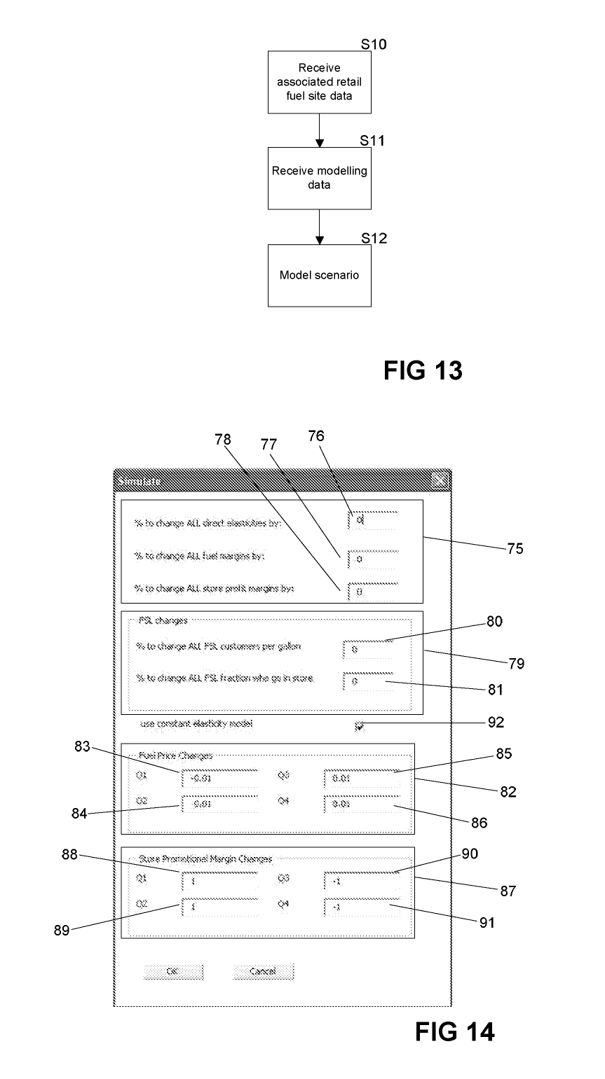

Referring to FIG. 13, at step S10 associated retail fuel site data is received. The received associated retail fuel site data includes current fuel prices, fuel sales margin and store sales margin, a percentage of fuel customers who purchase in store goods (determined based upon the values Fₜᵢ, average store spend per store customer and number of fuel customers per gallon fuel sold, as described above), fuel store coefficient and fuel price-volume sensitivity for the current site i. The received data is generally either generated based upon historical data from the site or is data indicative of current values or average values during a recent time period at the site. At step S11 modelling data is received. The modelling data is indicative of a possible scenario to be modelled as described above, and takes the form of a change to one of the data received at step S10. At step S12 the scenario is modelled for the retail fuel site to determine a total profit at the retail fuel site using the data received at steps S10 and S11. The total profit for the retail fuel site i is determined according to equation (14) below:

$${G}_{tik} + {S}_{ti} = ( \frac{{P}_{tik}}{1 + v} - {\tilde{C}}_{tik} ) f ( {V}_{sik} , {P}_{tik} , {P}_{tjk} ) \qquad ( 14 )$$

where all terms of equation (14) are as set out above. In the scenario modelling, competitor prices are assumed to remain the same.

The processing of FIG. 13 determines a total profit at an associated retail fuel site i based upon a modelled possible scenario. However in general it is desirable to model a scenario for a plurality of retail fuel sites to determine the impact of a change on those sites. For example a scenario may be modelled for all sites or for each site in one of the categories described with reference to FIGS. 12A and 12B in order to determine the impact of a change at sites in a particular category. Where a possible scenario is to be modelled for a plurality of retail fuel sites the processing of FIG. 13 is modified such that data is received for those associated retail fuel sites at step S10, and the modelling data is received at step S11 for those sites for which the possible scenario is to be modelled. Alternatively, data may be received for all associated retail fuel sites and a scenario may be modelled for the sites indicated by a user.

FIG. 14 shows a user interface suitable for receiving input corresponding to a scenario to be modelled. It can be seen that a region 75 has data input boxes 76, 77, 78 which allow a percentage change to be input for each of fuel-price sensitivity, fuel sales margin and store sales margin respectively for all associated retail fuel sites. A region 79 has data input boxes 80, 81 which allow a percentage change to be input for each of fuel customers per gallon and percentage of fuel customers who purchase in store goods respectively for all associated retail fuel sites. A region 82 has data input boxes 83, 84, 85, 86 which allow fuel price changes to be input for each category of retail fuel site, and a region 87 has data input boxes 88, 89, 90, 91 which allow store margin to be input for each category of retail fuel site.

In general terms, it is desirable to model fuel price changes and store margins for each category of retail fuel site to determine the impact of, for example, a store or fuel promotion on those retail fuel sites in a particular category, and as such, the user interface of FIG. 14 has data input boxes for those values for each category. It is further desirable to test the sensitivity of the scenario that is modelled by category by varying model parameters across the entire network of retail fuel sites and as such, data input boxes are provided for inputting changes to the parameters indicated. It will however be appreciated that any parameters may be modelled for all retail fuel sites, or alternatively for only those retail fuel sites in a particular category.

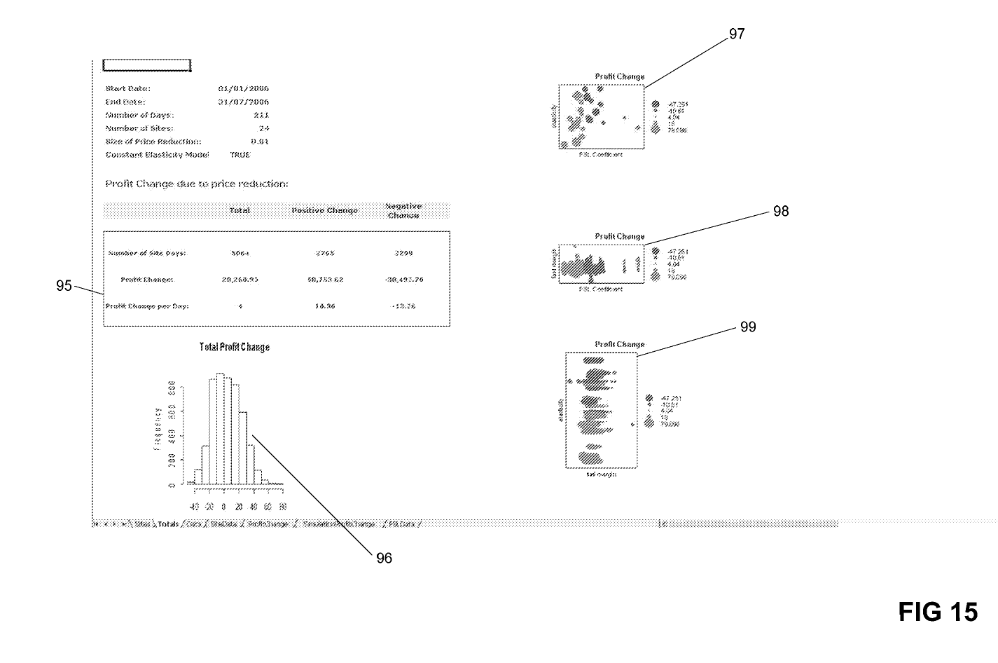

FIG. 15 shows an example output of the modelling of FIG. 13 in which the result of a price reduction of size 0.01 applied independently to each day of a 211 day historical period at each of 24 sites is shown. A summary box 95 provides an indication of the total number of site days (determined by multiplying the number of sites by the number of days=5064) together with a break down of those days into the number of days in which a positive change in total site profit would have occurred and the number of days in which a negative change in total site profit would have occurred. The total profit change across the plurality of sites relative to if no change is made (20,260.93) is also shown, together with a break down into the total positive change in profit for those site days in which the change would have been positive (50.753.62) and the total negative change in profit for those site days in which the change would have been negative (−30,492.70). Average profit change per site day is also shown for each of total (4), positive change (18.36) and negative change (−13.26).

A plurality of graphs shown in FIG. 15 provide data to a user of the system in a form that can be readily analysed. A histogram 96 indicates the distribution of profit change over the 5064 site days and three bubble plots 97, 98, 99 indicate the site day profit changes, indicated by green for a positive profit change and red for a negative profit change with size of bubble corresponding to size of profit change, for each pair of axes from the set of modelled input variables, elasticity, fuel-store coefficient and fuel margin in the modelling illustrated in FIG. 15. The bubble plots therefore show the impact on profit as two variables are varied and provide a visual representation that allows a user to identify combinations of modelled variables which contribute to a positive profit change.

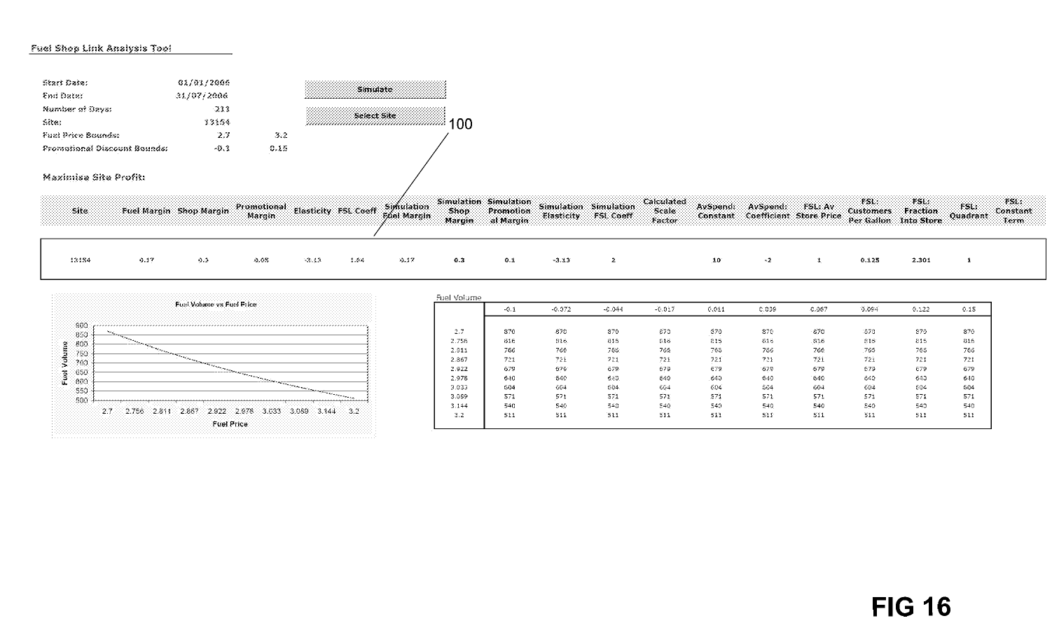

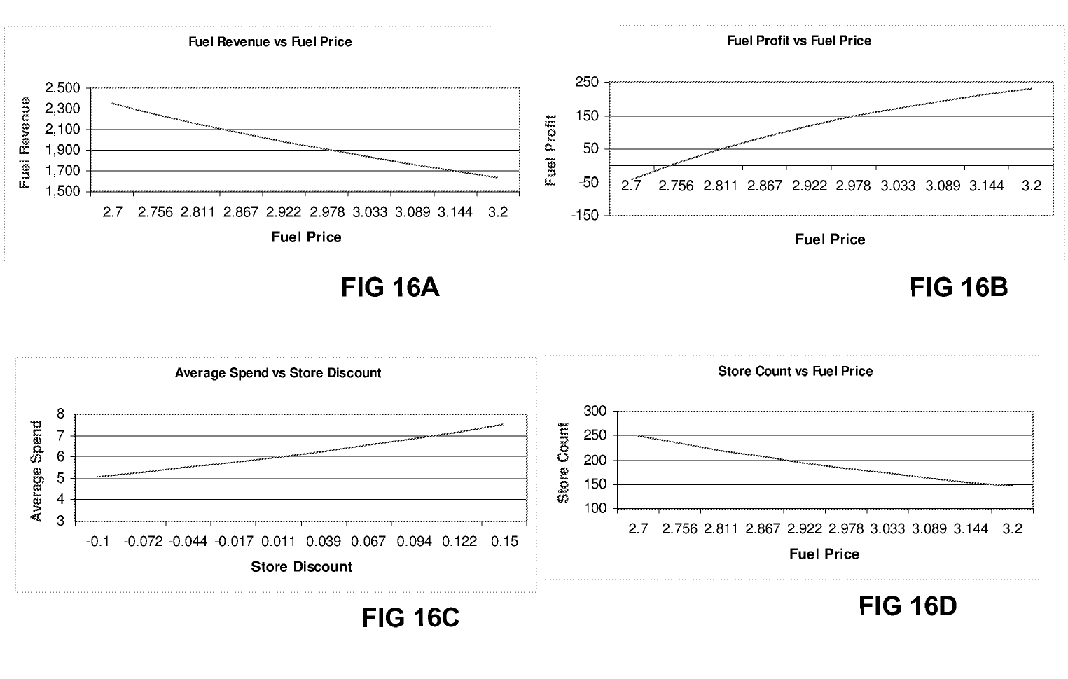

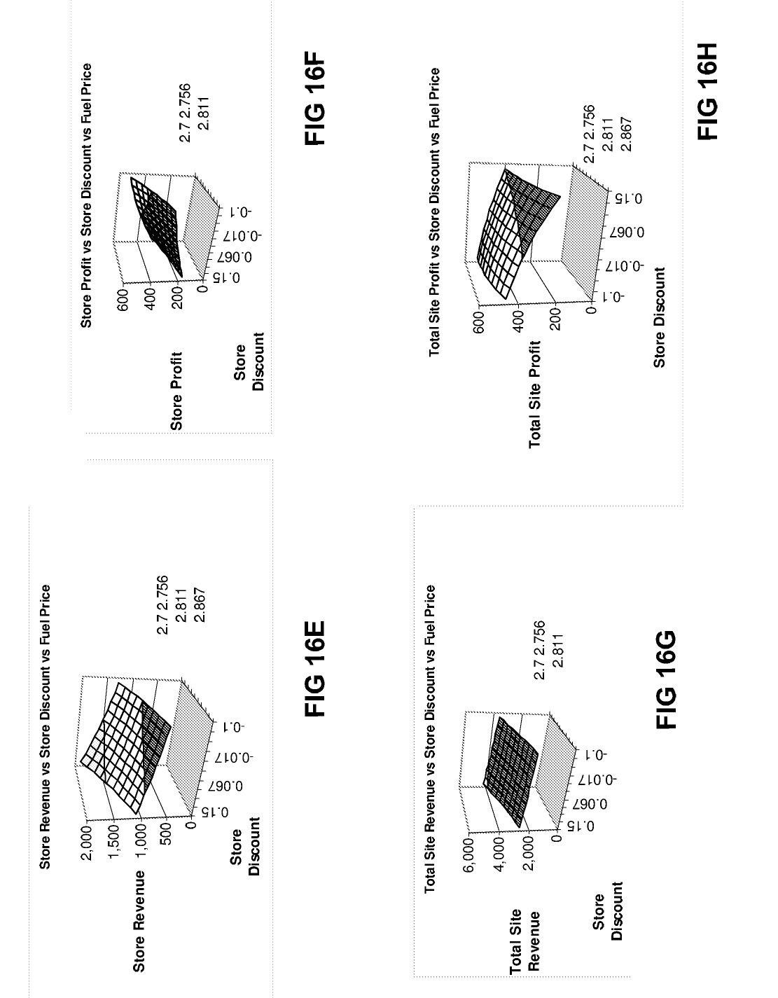

FIG. 16 shows part of a user interface for modelling scenarios for a single site having identification number 13154 over a period of 211 days. The interface takes as input historical and calculated data associated with the site including site fuel margin, shop margin, fuel price elasticity and fuel-store coefficient which is displayed in area 100, together with values used for the simulation. The interface additionally takes as input a range of fuel price bounds and promotional discount bounds within which fuel price and store margin variation is to be modelled for various parameters. The interface displays a plurality of tables and associated graphs, one of each of which is shown in FIG. 16 and others of which are shown in FIGS. 16A to 16H, indicating the effect of variation of fuel price and store margin within the user specified bounds. The effect of variation of fuel price and store margin is determined by modelling the various parameters according to equation (14) and equation (3). Each of the tables shown in FIGS. 16 and 16A to 16H display values for the indicated modelled quantity (for example Fuel Volume in the table of FIG. 16) as a function of a range of values for each of fuel price and store margin and the graphs provide a visual representation that allow a user to identify any trend of variation of the values. For example the graph of FIG. 16 provides an indication to a user that fuel volume decreases with respect to fuel price, as expected.

FIGS. 16A to 16D each show a graph indicating variation of a value indicated on the y-axis as an input value indicated on the x-axis varies. FIGS. 16A to 16D show respectively variation of fuel revenue with respect to fuel price, variation of fuel profit with respect to fuel price, variation of average in store spend with respect to store margin, and variation of the number of in store customers with respect to fuel price.

FIGS. 16E to 16H each show a graph indicating variation of a value indicated on the y-axis as two input values indicated on the x and z-axes vary. FIGS. 16E to 16H show respectively variation of store revenue as store margin and fuel price vary, store profit as store margin and fuel price vary, total site revenue as store margin and fuel price vary and total site profit as store margin and fuel price vary. It will be appreciated that a corresponding table for each of the graphs of FIGS. 16A to 16H is also provided to a user.

FIGS. 16A to 16H provide representation of a large amount of information to a user that can be readily interpreted. FIGS. 16A to 16H therefore allow a user to quickly and easily determine the effects of variation of fuel price and store margin on revenue, profit and sales.

Modelling possible retail fuel site scenarios as described above and generating output data such as the output data of FIGS. 15 and 16 allows a user to quickly and effectively analyse the effect of a possible scenario on a network of retail fuel sites.

It should be noted that in the above description the terms “optimal” and “optimised” are intended to mean generated using processing intended to select values based upon data. The values will generally be improved relative to a previous value and sometimes be a best possible value, but this is not necessarily the case.

Although specific embodiments of the invention have been described above, it will be appreciated that various modifications can be made to the described embodiments without departing from the spirit and scope of the present invention. That is, the described embodiments are to be considered in all respects exemplary and non-limiting. In particular, where a particular form has been described for particular processing, it will be appreciated that such processing may be carried out in any suitable form arranged to provide suitable output data.

1. A computer-implemented method of generating fuel price data for a retail fuel site, the method being implemented in a computer comprising a memory in communication with a processor, the method comprising:
receiving, as input to the processor, data indicating a relationship between fuel sales and store sales at said retail fuel site;
receiving, as input to the processor, data indicating a relationship between fuel price and fuel sales at said retail fuel site;
processing, by the processor, said data indicating a relationship between fuel sales and store sales at said retail fuel site and said data indicating a relationship between fuel price and fuel sales at said retail fuel site to generate said fuel price data.

2. A computer-implemented method according to claim 1, wherein said processing comprises:
generating a volume fuel sales target for said retail fuel site based upon said data indicating a relationship between fuel sales and store sales at said retail fuel site and said data indicating a relationship between fuel price and fuel sales at said retail fuel site; and
generating said fuel price data based upon said generated volume fuel sales target.

3. A computer-implemented method according to claim 2, wherein generating a volume fuel sales target for said retail fuel site comprises:
receiving, as input to the processor, data indicating a relationship between fuel sales and store sales at a plurality of associated retail fuel sites, said plurality of associated retail fuel sites including said retail fuel site;
receiving, as input to the processor, data indicating a relationship between fuel price and fuel sales at said plurality of associated retail fuel sites;
receiving, as input to the processor, a total volume fuel sales target for said plurality of associated retail fuel sites; and
processing, by the processor, said total volume fuel sales target for said plurality of associated retail fuel sites together with said data indicating a relationship between fuel sales and store sales at said plurality of associated retail fuel sites and said data indicating a relationship between fuel price and fuel sales at said plurality of associated retail fuel sites to generate said volume fuel sales target for said retail fuel site.

4. A computer-implemented method according to claim 3, wherein processing said total volume fuel sales target for said plurality of associated retail fuel sites together with said data indicating a relationship between fuel sales and store sales at said plurality of associated retail fuel sites and said data indicating a relationship between fuel price and fuel sales at said plurality of associated retail fuel sites to generate said volume fuel sales target for said retail fuel site comprises:
generating, by the processor, a price for said retail fuel site based upon said total volume sales target; and
processing, by the processor, said generated price for said retail fuel site to generate said volume fuel sales target for said associated retail fuel site.

5. A computer-implemented method according to claim 4, wherein generating a price for said retail fuel site based upon said total volume fuel sales target comprises:
performing, by the processor, an optimisation operation, said optimisation operation having said total volume fuel sales target as a constraint.

6. A computer-implemented method according to claim 5, wherein said optimisation operation is further based upon average fuel price data from each of said plurality of associated retail fuel sites and average fuel price data from each of a plurality of competitor retail fuel sites.

7. A computer-implemented method according to claim 6, wherein said optimisation operation is further based upon relationships between said plurality of associated retail fuel sites and said plurality of competitor retail fuel sites.

8. A computer-implemented method according to claim 7, wherein said relationships between each of said plurality of associated retail fuel sites and said plurality of competitor retail fuel sites are determined based upon a relationship between the data indicating a relationship between fuel sales and store sales at the associated retail fuel site and the data indicating a relationship fuel price and fuel sales at the retail fuel site.

9. A computer-implemented method according to claim 5, wherein said optimisation operation determines fuel price data which provides an optimal profit at said retail fuel site.

10. A computer-implemented method according to claim 9, wherein said optimal profit at said retail fuel site is based upon profit associated with fuel sales at said retail fuel site and profit associated with store sales at said retail fuel site.

11. A method according to claim 1, wherein said fuel price data is generated based upon a volume fuel sales target for said retail fuel site.

12. A computer-implemented method according to claim 11, wherein processing said volume fuel sales target to generate said fuel price data comprises:
performing, by the processor, an optimisation operation, said optimisation operation having said volume fuel sales target as a constraint.

13. A computer-implemented method according to claim 12, wherein said optimisation operation is further based upon relationships between said retail fuel site and a plurality of competitor retail fuel sites.

14. A computer-implemented method according to claim 12, wherein said optimisation operation determines fuel price data which provides an optimal profit at said retail fuel site.

15. A computer-implemented method according to claim 14, wherein said optimal profit at said retail fuel site is based upon profit associated with fuel sales at said retail fuel site and profit associated with store sales at said retail fuel site.

16. A computer readable medium carrying a computer program comprising computer readable instructions configured to cause a computer to carry out a method according to claim 1.

17. A computer apparatus for generating fuel price data for a retail fuel site, the apparatus comprising:
a memory storing processor readable instructions; and
a processor arranged to read and execute instructions stored in said memory;
wherein said processor readable instructions comprise instructions arranged to control the computer to carry out a method according to claim 1.

18. A computer-implemented method of generating price data for a retail fuel site, the method being implemented in a computer comprising a memory in communication with a processor, the method comprising:
receiving, as input to the processor, a model having a plurality of parameters, the model being based upon a relationship between fuel sales and store sales at said retail fuel site and being arranged to generate a profit based upon values of said plurality of parameters;
receiving, as input to the processor, first values for said parameters;
processing, by said processor, said model and said first values to generate a first profit value;
receiving, as input to the processor, second values for said parameters;
processing, by said processor, said model and said second values to generate a second profit value; and
determining said price data for said retail fuel site based upon said first and second profit values.

19. A computer-implemented method according to claim 18, wherein said first values for said parameters are based upon current values for said parameters and said second values for said parameters are based upon values other than current values for said parameters.

20. A computer-implemented method according to claim 19, wherein said profits generated by said model are based upon profit from fuel sales and profit from store sales.

21. A computer-implemented method according to claim 18, wherein said model models relationships between said retail fuel site and a plurality of competitor retail fuel sites.

22. A computer-implemented method according to claim 18, wherein said parameters include a relationship between fuel sales and store sales, a fuel sale margin, a store sale margin and a relationship between fuel price and fuel sales.

23. A computer-implemented method according to claim 18, wherein price data is generated for a plurality of associated retail fuel sites and said price data is determined for said retail fuel site based upon said first and second profit values for each of said plurality of associated retail fuel sites.

24. A computer-implemented method according to claim 23, wherein said plurality of associated retail fuel sites each have a predetermined relationship between an associated relationship between fuel sales and store sales and an associated relationship between fuel price and fuel sales.

25. A computer readable medium carrying a computer program comprising computer readable instructions configured to cause a computer to carry out a method according to claim 1.

26. A computer apparatus for generating fuel price data for a retail fuel site, the apparatus comprising:
a memory storing processor readable instructions; and
a processor arranged to read and execute instructions stored in said memory;
wherein said processor readable instructions comprise instructions arranged to control the computer to carry out a method according to claim 1.
